(19) United States
(12) Patent Application Publication
(10) Pub. No.: US 2025/0115783 A1
(43) Pub. Date: Apr. 10, 2025

(54) A 2K CLEARCOAT COATING COMPOSITION

(71) Applicant: BASF COATINGS GMBH, Muenster (DE)

(72) Inventors: Yang ZHANG, Shanghai (CN); Wei ZHANG, Shanghai (CN); Lei HE, Shanghai (CN); Jing Yu HUANG, Shanghai (CN); Xiao Gang YOU, Shanghai (CN)

(21) Appl. No.: 18/868,015

(22) PCT Filed: Jun. 14, 2023
(86) PCT No.: PCT/EP23/65955

§ 371 Date: Nov. 21, 2024

(30) Foreign Application Priority Data
Jun. 29, 2022 (WO) PCT/CN2022/102265

(51) Int. Cl. C09D 175/12; C08G 18/40; C08G 18/42; C08G 18/62; C08G 18/64

(52) U.S. Cl. CPC C09D 175/12; C08G 18/4081; C08G 18/42; C08G 18/6233; C08G 18/6423

(57) ABSTRACT

Disclosed herein is a 2K clearcoat coating composition including (A) from 10% to 70% by weight of a first resin having at least one primary hydroxyl group; (B) from 2% to 40% by weight of a second resin including a resin (B-1) having at least one primary hydroxyl group and/or a resin (B-2) having at least one secondary hydroxyl group; and (C) a crosslinker including at least one polyisocyanate and at least one amino resin, and the weight percentages of components (A) and (B) are based on the total weight of the coating composition and the ratio by weight between components (A) and (B) is in a range of from 6:1 to 1:2. Further disclosed herein is an article coated by the coating composition and the article may have metal substrates.

### TECHNICAL FIELD

The present invention relates to a coating composition and more specifically a 2K clearcoat coating composition used in automotive field.

### BACKGROUND

Clearcoat provides both decoration and protection for automotives as top coat and therefore it needs to have good appearance and scratch resistance as well as sufficient hardness at the same time. Morevoer, for environmental protection purpose, a coating composition to form clearcoat is asked to have low VOC. i.e. high solid content. Take China for instance, the low VOC regulation requires ready-to-use VOC values below 420 g/L for 2K coating composition, which equals to roughly ready-to-use solid content of at least 57% by weight. However, low VOC or high solid content brings high viscosity to the coating composition and it is difficult to apply a coating composition having high viscosity to obtain good appearance, not to mention those specific requirements from OEM manufactures.

In another side, in order to improve scratch resistance of clearcoat layer, sometimes nanosilica particles are added into a coating composition or Si-OR groups are grafted to resins or crosslinkers components of a coating composition, which, however, often brings negative impact on the appearance of clearcoat layers, especially in wet-on-wet process.

CN105612227A disclosed a coating composition comprising a main agent and a curing agent comprising a polyisocyanate compound, said main agent comprises a hydroxy-containing acrylic resin having relative lower glass transition temperature and a hydroxy-containing acrylic resin having relative higher glass transition temperature. Said coating composition forms a coating film that has excellent scratch resistance, hardness, appearance, and adhesion to a plastic substrate and has resistance to a composition containing UV absorbers. However, the coating film in CN105612227A is only suitable for a plastic substrate, but not suitable for a metal substrate under high baking temperatures (e.g. higher than 100° C.).

U.S. Pat. No. 7,423,077B2 disclosed a coating material comprising (A) at least one hydroxyl-containing (meth)acrylate (co)polymer, (B) at least one carbamate- and hydroxyl-functional compound, (C) at least one amino resin, and (D) at least one triazine compound. The amino resin and triazine compound were used as crosslinkers and alcohols were released during polycondensation reactions which lead to internal stress and strong shrinkage after cooling. As a result, negative impact was brought to the appearance of clearcoat layers, especially in wet-on-wet process.

Therefore, it is still required to provide a coating composition having high solid content and low viscosity simultaneously from which the obtained or obtainable clearcoat layers show good appearance and scratch resistance as well as sufficient hardness, and especially applicable for metal substrates under high baking temperatures (e.g. higher than 100° C.).

### SUMMARY OF THE INVENTION

In one aspect, the present invention provides a 2K clearcoat coating composition comprising (A) from 10% to 70% and preferably from 20% to 50% by weight of a first resin having at least one primary hydroxyl group;

(B) from 2% to 40% and preferably from 5% to 25% by weight of a second resin comprising a resin (B-1) having at least one primary hydroxyl group and/or a resin (B-2) having at least one secondary hydroxyl group; and
(C) a crosslinker comprising at least one polyisocyanate and at least one amino resin, wherein the weight percentages of components (A) and (B) are based on the total weight of the coating composition and the ratio by weight between components (A) and (B) is in a range from 6:1 to 1:2 and preferably from 4:1 to 1:1.

In another aspect, the present invention provides an article coated by the invented coating composition and said article preferably has metal substrate.

It is surprising to find that the coating composition of the present invention has low VOC and low viscosity simultaneously, from which the obtained or obtainable clearcoat layers show good appearance and scratch resistance as well as sufficient hardness, especially applicable for metal substrates under high baking temperature (e.g. higher than 100° C.).

### DETAILED DESCRIPTION OF THE INVENTION

The present invention will be described in detail hereinafter. It is to be understood that the present invention can be embodied in many different ways and shall not be construed as limited to the embodiments set forth herein.

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

As used herein, the terms “comprise”, “comprising”, etc. are used interchangeably with “contain”, “containing”, etc. and are to be interpreted in a non-limiting, open manner. That is, e.g., further components or elements can be present. The expressions “consists of” or “consists essentially of” or cognates can be embraced within “comprises” or cognates.

Unless otherwise identified, all percentages (%) are “percent by weight” and parts indicate parts by weight.

In the present invention, “(meth)acrylate” means acrylate and methacrylate, “(meth)acrylic” means acrylic acid and methacrylic acid, “(meth)acrylamide” means acrylamide and methacrylamide, “acrylic resin” includes acrylic resin and methacrylic resin, and “acrylic monomer” includes acrylic monomer and methacrylic monomer.

In the present invention, the acid value is determined in accordance with DIN EN ISO 2114 (date: June 2002).

In the present invention, the OH value (OHV) is determined in accordance with DIN 53240-2 (date: November 2007).

In the present invention, the solid content was determined in accordance with DIN EN ISO 3251 (date: June 2008).

In the present invention, the weight average molecular weights are determined in accordance with DIN 55672-1 (date: August 2007).

In the present invention, the glass transition temperature of a copolymer is the numerical value calculated using the equation indicated below:

1/Tg (K)=Σ(mi/Tgi)

Tg (° C.)=Tg (K)−273

Tg: Glass transition temperature of the copolymer
mi: Mol fraction of the monomer component i
Tgi: Glass transition temperature (K) of a homopolymer of the monomer component i.

In addition, glass transition temperature (K) of a homopolymer of the monomer component i is based on the value obtained by POLYMER HANDBOOK Fourth Edition, J. Brandrup, E.h. Immergut, E.A. Grulke, ed. (1999). For homopolymers of a monomer not described in this document, the glass transition temperature may be determined by synthesizing a homopolymer of the monomer with a weight average molecular weight of about 50,000 and measuring the glass transition temperature by differential scanning thermal analysis.

### First Resin

The first resin has at least one primary hydroxyl group and a Tg (glass transition temperature) in a range of from −80° C. to 0° C., preferably from −60° C. to −10° C., more preferably from −50° C. to −20° C., such as −40° C. and −30° C., etc.

The first resin has a hydroxyl value (OH value) in a range of from 100 to 240 mgKOH/g, preferably from 150 to 200 mgKOH/g, such as 110 mgKOH/g, 120 mgKOH/g, 130 mgKOH/g, 140 mgKOH/g, 160 mgKOH/g, 170 mgKOH/g, 180 mgKOH/g, 190 mgKOH/g, 210 mgKOH/g, 220 mgKOH/g and 230 mgKOH/g, etc.

The first resin has a weight average molecular weight in a range of from 2,000 to 10,000, preferably from 4,000 to 8,000, such as 3,000, 4,000, 5,000, 6,000, 7,000, 8,000 and 9,000, etc.

In one preferred embodiment of the present invention, the first resin is an acrylic resin containing at least one primary hydroxyl group in the molecule.

The acrylic resin containing at least one primary hydroxyl group can be synthesized by copolymerizing a primary hydroxyl-containing acrylic monomer and other copolymerizable monomers by a conventional method such as radical polymerization.

Examples of the primary hydroxyl-containing acrylic monomers include hydroxyl alkyl (meth)acrylates with C₁ to C₁₀ and preferably C₂ to C₆ alkyl group, such as 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, and ethylene oxide and/or propylene oxide adducts of 2-hydroxyethyl (meth)acrylate, 3-hydroxypropyl (meth)acrylate, 4-hydroxybutyl (meth)acrylate, preferably 2-hydroxyethyl acrylate (2-HEA), 2-hydroxyethyl methacrylate (2-HEMA), 3-hydroxypropyl acrylate (3-HPA), 3-hydroxypropyl methacrylate (3-HPMA), 4-hydroxybutyl acrylate (4-HBA), and 4-hydroxybutyl methacrylate (4-HBMA). The primary hydroxyl-containing acrylic monomers can be used alone or in combination of two or more monomers.

Preferably, the primary hydroxyl-containing acrylic monomer is at least one selected from a group consisting of 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, or combination thereof, more preferably 2-hydroxyethyl (meth)acrylate, 3-hydroxypropyl (meth)acrylate and 4-hydroxybutyl (meth)acrylate.

Examples of the other copolymerizable monomers include C₁-C₂₀-alkyl (meth)acrylate, preferably C₁-C₁₀-alkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, lauryl (meth)acrylate, isobornyl (meth)acrylate, stearyl (meth)acrylate; cyclohexyl methacrylate (CHMA); styrene; (meth)acrylic acid; maleic acid; caprolactone; maleic anhydride; N, N-dimethylaminoethyl (meth)acrylate; N,N-diethylaminoethyl (meth)acrylate; N,N-dimethylaminopropyl (meth)acrylate; aminoalkyl (meth)acrylate; (meth) acrylamide or its derivatives, such as N,N-dimethylaminoethyl(meth)acrylamide, N,N-diethylaminoethyl(meth)acrylamide, N,N-dimethylaminopropyl (meth)acrylamide, N-methylol acrylamide, N-methylol acrylamide methyl ether, N-methylol acrylamide butyl ether. The other copolymerizable monomers can be used alone or in combination of two or more monomers.

Preferably, the other copolymerizable monomer is at least one selected from a group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, (meth)acrylic acid, caprolactone; styrene or combination thereof, preferably methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, (meth)acrylic acid, caprolactone and styrene.

The first resin comprises at least 60%, preferably at least 70% and more preferably at least 80% by weight of units derived from acrylic monomer, such as 60% by weight, 65% by weight, 70% by weight, 75% by weight, 80% by weight, 85% by weight, 90% by weight and 95% by weight, etc., based on the total weight of the first resin. Said acrylic monomers include any acrylic monomers having at least one primary hydroxyl group and other copolymerizable monomers.

In one preferred embodiment of the present invention, the first resin comprises from 60% to 95% by weight of units derived from acrylic monomer, such as from 70% to 90% by weight, and from 75% to 85% by weight, etc., based on the total weight of the first resin.

The first resin comprises from 30% to 50% and preferably from 35% to 45% by weight of units derived from the primary hydroxyl-containing acrylic monomers, such as 40% by weight, based on the total weight of the first resin.

The first resin comprises from 50% to 70% and preferably from 55% to 65% by weight of units derived from the other copolymerizable monomer, such as 60% by weight, based on the total weight of the first resin.

The 2K coating composition comprises from 10% to 70% and preferably from 20% to 50% by weight of the first resin, such as 10% by weight, 20% by weight, 30% by weight, 40% by weight, 50% by weight, 60% by weight and 70% by weight, etc. based on the total weight of the coating composition.

Preferably, the first resin has an acid value in a range of from 0 to 30 KOH/mg/g, such as 5 KOH/mg/g, 10 KOH/mg/g, 15 KOH/mg/g, etc.

The first resin can be produced by a conventional method such as radical polymerization. Examples of the radical polymerization initiator include azo compounds such as 2,2′-azobisisobutyronitrile, 2,2′-azobis-2,4-dimethyl-valeronitrile, 4,4′-azobis-4-cyanovaleric acid, 1-azobis-1-cyclohexanecarbonitrile, dimethyl-2,2′-azobisisobutyrate and the like, and organic peroxides such as methyl ethyl ketone peroxide, cyclohexanone peroxide, 3,5,5-trimethylhexanone peroxide, 1,1-bis(t-butylperoxy)-3,3,5-trimethylcyclohexane, 1,1-bis(t-butylperoxy)-cyclohexane, 2,2-bis(t-butylperoxy)octane, t-butylhydroperoxide, diisopropyl benzenehydroperoxide, dicumyl peroxide, di-tert-butyl peroxide (DTBP), t-butylcumyl peroxide, isobutyl peroxide, lauroyl peroxide, benzoyl peroxide, diisopropylperoxydicarbonate, tertiary butylperoxy-2-ethylhexanoate (TBPEH), t-butylperoxy neodecanate, t-butylperoxy laurate, t-butylperoxy benzoate, t-butylperoxy isopropylcarbonate and the like. One of these radical polymerization initiators can be used alone, or a combination of two or more types can be used.

No particular limitation is imposed upon the amount of radical polymerization initiator, but an amount of from 0.01% to 20% by weight based on the total weight of radically polymerizable monomer is preferred.

Examples of appropriate organic solvents which can be used in the production of the first resin include aliphatic hydrocarbon based solvents such as cyclohexane, ethylcyclo hexane and the like, aromatic hydrocarbon based solvents such as toluene, xylene, ethylbenzene, aromatic naphtha and the like, ketone based solvents such as acetone, methyl ethyl ketone, methyl isobutyl ketone, cyclohexanone, isophorone and the like, ester based solvents such as ethyl acetate, n-butyl acetate, isobutyl acetate, 3-methoxybutyl acetate, bis(2-ethylhexyl) adipate and the like, ether based solvents such as dibutyl ether, tetrahydrofuran, 1, 4-dioxane, 1, 3, 5-trioxane and the like, and nitrogen containing solvents such as acetonitrile, valeronitrile, N,N-dimethyl-formamide, N,N-diethylformamide and the like. The organic solvent can be of one type, or it can be a mixed solvent comprising a plurality of two or more types.

The method of adding the organic solvent and the radical polymerization initiator when producing the first resin is optional, but with a view to controlling the heat of polymerization and the heat of reaction, the method in which an organic solvent is introduced into the reactor and the radically polymerizable monomer or an organic solution thereof is drip-fed from a drop-feed tank, with stirring is preferred.

The polymerization temperature of the abovementioned polymerization reaction differs according to the type of radical polymerization initiator, but it is preferably carried out at a temperature in a range of from 50° C. to 200° C., more preferably from 100° C. to 160° C., such as 60° C., 70° C., 80° C., 90° C., 100° C., 110° C., 120° C., 130° C., 140° C., 150° C., 160° C., 170° C., 180° C. and 190° C., etc.

### Second Resin

The second resin is at least one selected from resin (B-1) having at least one primary hydroxyl group and a Tg in a range of from 0° C. to 30° C. and resin (B-2) having at least one secondary hydroxyl group and a Tg of at least 20° C.

In one embodiment of the present invention, the second resin is resin (B-1) having at least one primary hydroxyl group and a Tg in a range of from 0° C. to 30° C., preferably from 5° C. to 20° C., such as 10° C., 15° C. and 25° C., etc.

The resin (B-1) has a hydroxyl value in a range of from 100 to 240 mgKOH/g, preferably from 150 to 200 mgKOH/g, such as 110 mgKOH/g, 120 mgKOH/g, 130 mgKOH/g, 140 mgKOH/g, 150 mgKOH/g, 160 mgKOH/g, 170 mgKOH/g, 180 mgKOH/g, 190 mgKOH/g, 200 mgKOH/g, 210 mgKOH/g, 220 mgKOH/g and 230 mgKOH/g, etc.

The resin (B-1) has a weight average molecular weight in a range of from 2,000 to 10,000, preferably in a range of from 3,000 to 7,000, such as 3,000, 3,500, 4,000, 4,500, 5,000, 5,500, 6,500, 7,000, 7,500, 8,000, 8,500 and 9,000, etc.

In one preferred embodiment of the present invention, the resin (B-1) is an acrylic resin containing at least one primary hydroxyl group in the molecule.

The resin (B-1) comprises monomeric units derived from primary hydroxyl alkyl (meth) acrylates having C₁-C₁₀ and preferably C₂-C₆ alkyl groups.

The acrylic resin containing at least one primary hydroxyl group can be synthesized by copolymerizing a primary hydroxyl-containing acrylic monomer and other copolymerizable monomers by a conventional method such as radical polymerization.

Examples of the primary hydroxyl-containing acrylic monomers include hydroxyl alkyl (meth) acrylates with the alkyl having a carbon atom number in the range from 1 to 10, preferably in the range from 2 to 6, such as 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, and ethylene oxide and/or propylene oxide adducts of 2-hydroxyethyl (meth)acrylate, 3-hydroxypropyl (meth)acrylate, 4-hydroxybutyl (meth)acrylate, preferably 2-hydroxyethyl acrylate (2-HEA), 2-hydroxyethyl methacrylate (2-HEMA), 3-hydroxypropyl acrylate (3-HPA), 3-hydroxypropyl methacrylate (3-HPMA), 4-hydroxybutyl acrylate (4-HBA), and 4-hydroxybutyl methacrylate (4-HBMA). The primary hydroxyl-containing acrylic monomers can be used alone or in combination of two or more monomers.

Preferably, the primary hydroxyl-containing acrylic monomers is at least one selected from a group consisting of 2-hydroxyethyl (meth)acrylate, 3-hydroxypropyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, 9-hydroxynonyl (meth)acrylate, or combination thereof, more preferably 2-hydroxyethyl (meth)acrylate, 3-hydroxypropyl (meth)acrylate and 4-hydroxybutyl (meth)acrylate.

Examples of the other copolymerizable monomers include C₁-C₂₀-alkyl (meth)acrylate, preferably C₁-C₁₀-alkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, lauryl (meth)acrylate, isobornyl (meth)acrylate, stearyl (meth)acrylate; cyclohexyl methacrylate (CHMA); styrene; (meth)acrylic acid; maleic acid; maleic anhydride; N, N-dimethylaminoethyl (meth)acrylate; N,N-diethylaminoethyl (meth)acrylate; N,N-dimethylaminopropyl (meth)acrylate; aminoalkyl (meth)acrylate; (meth) acrylamide or its derivatives, such as N,N-dimethylaminoethyl(meth)acrylamide, N,N-diethylaminoethyl(meth)acrylamide, N,N-dimethylaminopropyl (meth)acrylamide, N-methylol acrylamide, N-methylol acrylamide methyl ether, N-methylol acrylamide butyl ether. The other copolymerizable monomers can be used alone or in combination of two or more monomers.

Preferably, the other copolymerizable monomers is at least one selected from a group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, (meth)acrylic acid, styrene or combination thereof, preferably methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, (meth)acrylic acid and styrene.

The resin (B-1) comprises at least 60% and preferably at least 70% by weight of units derived from acrylic monomer, such as 75% by weight, 80% by weight, 85% by weight, 90% by weight and 95% by weight, etc., based on the total weight of the resin (B-1). Said acrylic monomers include any primary hydroxyl-containing acrylic monomers and the other copolymerizable monomers.

In one preferred embodiment of the present invention, the resin (B-1) comprises from 60% to 95% by weight of units derived from acrylic monomer, such as from 65% to 75% by weight, based on the total weight of the resin (B-1).

The resin (B-1) comprises from 30% to 50% and preferably from 35% to 45% by weight of units derived from the primary hydroxyl-containing acrylic monomers, such as 40% by weight, based on the total weight of the resin (B-1).

The resin (B-1) comprises from 50% to 70% and preferably from 55% to 65% by weight of units derived from the other copolymerizable monomer, such as 60% by weight, based on the total weight of the resin (B-1).

In another embodiment of the present invention, the second resin is resin (B-2) having at least one secondary hydroxyl group and a Tg of at least 20° C., preferably at least 25° C. and more preferably at least 30° C., for example in a range of from 20° C. to 150° C., preferably from 25° C. to 100° C., more preferably from 30° C. to 50° C., such as 35° C., 40° C., 45° C., 55° C., 60° C., 65° C., 70° C., 75° C., 80° C., 85° C., 90° C., 95° C., 100° C., 110° C., 120° C., 130° C. and 140° C., etc.

The resin (B-2) has a hydroxyl value in a range of from 100 to 200 mgKOH/g, preferably from 130 to 170 mgKOH/g, such as 100 mgKOH/g, 120 mgKOH/g, 130 mgKOH/g, 140 mgKOH/g, 150 mgKOH/g, 160 mgKOH/g, 170 mgKOH/g, 180 mgKOH/g, 190 mgKOH/g and 200 mgKOH/g, etc.

The resin (B-2) has a weight average molecular weight in a range of from 2,000 to 10,000, preferably from 3,000 to 7,000, such as 3,000, 3,500, 4,000, 4,500, 5,000, 5,500, 6,500, 7,000, 7,500, 8,000, 8,500 and 9,000, etc.

In one preferred embodiment of the present invention, the resin (B-2) is an acrylic resin containing at least one secondary hydroxyl group in the molecule.

The resin (B-2) comprises monomeric units derived from hydroxyl alkyl (meth) acrylates having C₁-C₁₀ and preferably C₂-C₆ alkyl group.

The acrylic resin containing at least one secondary hydroxyl group can be synthesized by copolymerizing a secondary hydroxyl-containing acrylic monomer and other copolymerizable monomers by a conventional method such as radical polymerization.

Examples of the secondary hydroxyl-containing acrylic monomers include hydroxyl alkyl (meth) acrylates with the alkyl having a carbon atom number in the range from 2 to 10, preferably in the range from 2 to 6, such as 1-hydroxylethyl (meth)acrylate, 1- or 2-hydroxypropyl (meth)acrylate, 1-, 2- or 3-hydroxy butyl (meth)acrylate, 1-, 2-, 3- or 4-hydroxypentyl (meth)acrylate, 1-, 2-, 3-, 4- or 5-hydroxyhexyl (meth)acrylate, 1-, 2-, 3-, 4-, 5- or 6-hydroxyheptyl (meth)acrylate, 1-, 2-, 3-, 4-, 5-, 6- or 7-hydroxyoctyl (meth)acrylate, and ethylene oxide and/or propylene oxide adducts of 1-hydroxylethyl (meth)acrylate, 1- or 2-hydroxypropyl (meth)acrylate, 1-, 2- or 3-hydroxy butyl (meth)acrylate, preferably 1-hydroxyethyl (meth)acrylate, 1- or 2-hydroxypropyl (meth)acrylate and 1-, 2- or 3-hydroxybutyl methacrylate. The secondary hydroxyl-containing acrylic monomers can be used alone or in combination of two or more monomers.

Preferably, the secondary hydroxyl-containing acrylic monomers is at least one selected from a group consisting of 1-hydroxyethyl acrylate (1-HEA), 1-hydroxyethyl methacrylate (1-HEMA), 1- or 2-hydroxypropyl acrylate (1- or 2-HPA), 1- or 2-hydroxypropyl methacrylate (1-or 2-HPMA), 1-, 2-or 3-hydroxybutyl acrylate (1-, 2- or 3-HBA) and 1-, 2- or 3-hydroxybutyl methacrylate (1-, 2- or 3-HBMA), and more preferably 2-hydroxypropyl methacrylate (2-HPMA).

Examples of the other copolymerizable monomers include C₁-C₂₀-alkyl (meth)acrylate, preferably C₁-C₁₀-alkyl (meth)acrylate, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, lauryl (meth)acrylate, isobornyl (meth)acrylate, stearyl (meth)acrylate; cyclohexyl methacrylate (CHMA); styrene; (meth)acrylic acid; maleic acid; maleic anhydride; N, N-dimethylaminoethyl (meth) acrylate; N,N-diethylaminoethyl (meth)acrylate; N,N-dimethylaminopropyl (meth)acrylate; aminoalkyl (meth)acrylate; (meth)acrylamide or its derivatives, such as N,N-dimethylaminoethyl (meth)acrylamide, N,N-diethylaminoethyl (meth)acrylamide, N,N-dimethylaminopropyl (meth)acrylamide, N-methylol acrylamide, N-methylol acrylamide methyl ether, N-methylol acrylamide butyl ether. The other copolymerizable monomers can be used alone or in combination of two or more monomers.

Preferably, the other copolymerizable monomers is at least one selected from a group consisting of methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, cyclohexyl (meth)acrylate, n-octyl (meth)acrylate, 2-ethylhexyl (meth)acrylate, nonyl (meth)acrylate, (meth)acrylic acid, styrene or combination thereof, preferably methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, (meth)acrylic acid and styrene.

The resin (B-2) comprises at least 70%, preferably at least 80% and more preferably at least 90% by weight of units derived from acrylic monomer, such as 75% by weight, 80% by weight, 85% by weight, 90% by weight and 95% by weight, etc., based on the total weight of the resin (B-2). Said acrylic monomers include any secondary hydroxyl-containing acrylic monomers and other copolymerizable monomers.

In one preferred embodiment of the present invention, the resin (B-2) comprises from 85% to 95% by weight of units derived from acrylic monomer, based on the total weight of the resin (B-2).

The resin (B-2) comprises from 30% to 50% and preferably from 35% to 45% by weight of units derived from the secondary hydroxyl-containing acrylic monomers, such as 40% by weight, based on the total weight of the resin (B-2).

The resin (B-2) comprises from 50% to 70% and preferably from 55% to 65% by weight of units derived from the other copolymerizable monomer, such as 60% by weight, based on the total weight of the resin (B-2).

The coating composition comprises from 2% to 40% and preferably from 5% to 25% by weight of the second resin, such as 5% by weight, 10% by weight, 15% by weight, 20% by weight, 25% by weight, 30% by weight and 35% by weight, etc., based on the total weight of the coating composition.

Preferably, the second resin has an acid value in a range of from 0 to 30 KOH/mg/g, such as 5 KOH/mg/g, 10 KOH/mg/g and 15 KOH/mg/g, etc.

The ratio by weight between the first resin and the second resin in the coating composition is in a range of from 6:1 to 1:2 and preferably from 4:1 to 1:1, such as 2:1, 3:1, 4:1 and 5:1, etc.

The second resin can be produced by a conventional method such as radical polymerization, and the method for preparing the first resin is also applicable for the second resin.

### Crosslinker

In the present invention, the crosslinker comprises at least one polyisocyanate and at least one amino resin.

The polyisocyanate having at least two and preferably at least three isocyanate groups can be used as a crosslinker in the coating composition of the present invention, and one type or a combination of two or more types of polyisocyanate can be used.

Examples of polyisocyanate having at least two isocyanate groups per molecule include aliphatic, cycloaliphatic, araliphatic and/or aromatic isocyanates, such as 1,4-tetra-methylenediisocyanate, hexamethylenediisocyanate (HDI), 2,2,4-trimethylhexane-1,6-diisocyanate, methylcyclohexyl-diisocyanate, p-phenylenediisocyanate, biphenyldiisocyanate, tolylenediisocyanate, 3,3′-dimethyl-4,4′-biphenylenediisocyanate, methylenebis(phenylisocyanate), lysine methyl ester diisocyanate, 1-isocyanato-3,3,5-trimethyl-5-isocyanatomethylcyclohexane (isophorone diisocyanate, IPDI), 2-isocyanatoethyl-2,6-diisocyanatohexanoate, 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate, the biuret forms, isocyanurate forms of these compounds, oligomeric or polymeric isocyanates, or a mixture thereof.

In one preferred embodiment, the polyisocyanate is an aliphatic polyisocyanate, such as Desmodur N100, N75, N3200, N3400, N3600, Desmodur 3390 and DesmodurZ4470 from Covestro.

In one preferred embodiment, the polyisocyanate is an oligomeric isocyanate compound, such as isocyanate dimers, isocyanate trimers, etc.

In one particular embodiment, the polyisocyanate is a trimer of HDI, such as Desmodur 3390 from Covestro.

The ratio by molar between NCO groups in polyisocyanate and hydroxyl groups in both of the first resin and the second resin is in a range of from 1.6:1 to 0.7:1 and preferably from 1.35:1 to 1.05:1.

The amino resins are condensation products of aldehydes, especially formaldehyde, with, for example, urea, melamine, guanamine and benzoguanamine. The amino resins contain alcohol groups, preferably methylol groups, which in general are partly or, preferably, fully etherified with alcohols. Use is made in particular of melamine-formaldehyde resins etherified with lower alcohols, particularly with methanol or butanol. Very particular preference is given to using as crosslinkers melamine-formaldehyde resins which are etherified with lower alcohols, especially with methanol and/or ethanol and/or butanol.

In this context, it is possible to use any amino resins suitable for transparent topcoat or clearcoat materials, or a mixture of such resins. Particularly suitable are the conventional amino resins, some of whose methylol and/or methoxymethyl groups have been defunctionalized by means of carbamate or allophanate groups.

Crosslinkers of this kind are described in patents U.S. Pat. No. 4,710,542 A and EP 0 245 700 B1 and also in the article by B. Singh and Coworkers, “Carbamylmethylated Melamines, Novel Crosslinkers for the Coatings Industry” in Advanced Organic Coatings Science and Technology Series, 1991, Volume 13, pages 193 to 207. On the melamine resins reference may also be made to Rompp Lexikon Lacke und Druckfarben, 1988, pages 374 and 375, “Melamine resins” and to the book “Lackadditive” [Additives for Coatings] by Johan Bieleman, 1988, pages 242 to 250, section on “Melamine-resin-crosslinking systems”.

It is preferred if the crosslinker comprises at least 60%, preferably at least 70% and more preferably at least 80% by weight of melamine resin based on the total weight of the crosslinker comprising melamine resin and amino resin.

Melamine resins are well known to the skilled person and are supplied by numerous companies as sales products. Examples of suitable, low molecular mass, fully etherified melamine resins are Cymel® 301 and 303 from Cytec, Luwipal® 066 from BASF Aktiengesellschaft, Resimene® and Maprenal® MF from Solutia.

Examples of suitable, comparatively low molecular mass, highly etherified melamine resins containing free imino groups are Cymel® 325 and 327 (methanol-etherified), Cymel 202 and 203 (methanol- & butanol-etherified mixture) and 1158 (butanol-etherified) from Cytec, Luwipal® 062 (methanol-etherified), 018 (butanol-etherified), and 014 (butanol-etherified, of relatively high viscosity) from BASF Aktiengesellschaft, Maprenal® MF 927 and 3950 (methanol-etherified), VMF 3611 and 3615 (butanol-etherified) and 580 (isobutanol-etherified), and also Resimene® 717 and 718 (methanol-etherified), and 750 and 5901 (butanol-etherified), and also MB 9539 from Solutia and Setamine® US 138 and US 146 (butanol-etherified) from Akzo Resins.

Examples of suitable, comparatively low molecular mass, partially etherified melamine resins are Luwipal® 012, 016, 015 and 010 from BASF Aktiengesellschaft, Maprenal® MF 590 and 600 from Solutia and Setamine® US 132 and 134 from Akzo Resins.

The amount of the amino resin is in a range of from 1% to 30%, preferably from 5% to 15% by weight, based on the total weight of the coating composition, such as 3% by weight, 8% by weight, 10% by weight, 12% by weight, 16% by weight, 18% by weight, 20% by weight and 25% by weight, etc.

In one preferred embodiment according to the present invention, the 2K coating composition comprises (A) a first resin having at least one primary hydroxyl group and a Tg in a range of from −50° C. to −20° C.; (B) a second resin having at least one primary hydroxyl group and a Tgtemperature in a range of from 5° C. to 20° C.; and (C) a crosslinker comprising at least one polyisocyanate and at least one amino resin.

In one particular embodiment according to the present invention, the 2K coating composition comprises (A) an acrylic resin having at least one primary hydroxyl group and a Tg in a range of from −50° C. to −20° C.; (B) an acrylic resin having a primary hydroxyl group and a Tg in a range of from 5° C. to 20° C.; and (C) a crosslinker comprising an aliphatic polyisocyanate and a melamine resin.

In another particular embodiment according to the present invention, the 2K coating composition comprises (A) an acrylic resin having at least one primary hydroxyl group, a Tg in a range of from −50° C. to −20° C., and a weight average molecular weight in a range of from 4,000 to 8,000; (B) an acrylic resin having at least one primary hydroxyl group, a Tg in a range of from 5° C. to 20° C., and a weight average molecular weight in a range of from 3,000 to 7,000; and (C) a crosslinker comprising an aliphatic polyisocyanate and a melamine resin.

In one preferred embodiment according to the present invention, the 2K coating composition comprises (A) a first resin having at least one primary hydroxyl group and a Tg in a range of from −50° C. to −20° C.; (B) a second resin having at least one secondary hydroxyl group and a Tg in a range of from 30° C. to 50° C.; and (C) a crosslinker comprising a polyisocyanate and an amino resin.

In one particular embodiment according to the present invention, the 2K coating composition comprises (A) an acrylic resin having at least one primary hydroxyl group and a Tg in a range of from −50° C. to −20° C.; (B) an acrylic resin having at least one secondary hydroxyl group and a Tg in a range of from 30° C. to 50° C.; and (C) a crosslinker comprising an aliphatic polyisocyanate and a melamine resin.

In another particular embodiment according to the present invention, the 2K coating composition comprises (A) an acrylic resin having at least one primary hydroxyl group, a Tg in a range of from −50° C. to −20° C., and a weight average molecular weight in a range of from 4,000 to 8,000; (B) an acrylic resin having at least one secondary hydroxyl group, a Tg in a range of from 30° C. to 50° C., and a weight average molecular weight in a range of from 3,000 to 7,000; and (C) a crosslinker comprising an aliphatic polyisocyanate and a melamine resin.

Various additives can be added, for example, levelling agent, sag control agent, defoamer, light stabilizer, ultraviolet absorber, coloring agent, antioxidant, surfactant, surface controlling agent, hardening reaction catalyst, anti-static agent, perfume, de-watering agent and rheology controlling agents such as polyethylene wax, polyamide wax, fine internally crosslinked type resin particles and the like, as required.

The coating compositions of the present invention can be used as clearcoat, or color paints with additon of dyes and pigments etc.

The application of the invented coating composition is carried out by using any approach in the prior art, such as air sprayer, electrostatic air sprayer, roll coater, flow coater or dipping or a brush or a bar coater, or applicator or the like. And spray painting is preferred in this invention.

No particular limitation is imposed upon the thickness of a paint film obtained by applying the invented coating composition, but the thickness of paint films after drying is preferably in a range from 10 μm to 150 μm and more preferably from 30 μm to 60 μm.

Furthermore, examples of the substrate materials for painting the invented coating composition include both inorganic materials and organic materials such as metal, wood, glass, cloth, plastics, foams, elastomers, paper, ceramics, concrete, plaster-board and the like, and metal substrates are preferred. These substrate materials can be with or without pre-treatment

Examples of the obtained or obtainable coated articles include metal products, structural materials, wooden products, plastic products, rubber products, paper products, ceramic products, glass products and the like, and more specifically, they include automobiles and automobile parts (for example bodies, bumpers, spoilers, mirrors, wheels, interior decorative parts and the like, which are made of a variety of materials), metal sheets such as steel sheets, bicycles, bicycle parts, materials used on roads (for example guard rails, traffic signs, sound-deadening walls and the like), materials used in tunnels (for example side wall panels and the like), ships, railway rolling stock, aircraft, furniture, musical instruments, domestic electrical goods, building materials, containers, office accessories, sports accessories, toys and the like and metal products are preferred.

### EMBODIMENT

Although the following detailed description gives specific preferred embodiments, the persons skilled in the art should understand that these embodiments are only for example and the present invention can be practiced in alternative ways.

### Embodiment 1

A 2K clearcoat coating composition comprising

(A) from 10% to 70% and preferably from 20% to 50% by weight of a first resin having at least one primary hydroxyl group;
(B) from 2% to 40% and preferably from 5% to 25% by weight of a second resin comprising a resin (B-1) having at least one primary hydroxyl group and/or a resin (B-2) having at least one secondary hydroxyl group; and
(C) a crosslinker comprising at least one polyisocyanate and at least one amino resin, wherein the weight percentages of components (A) and (B) are based on the total weight of the coating composition and the ratio by weight between components (A) and (B) is in a range from 6:1 to 1:2 and preferably from 4:1 to 1:1.

### Embodiment 2

The coating composition according to embodiment 1, wherein said first resin has a Tg of from −80° C. to 0° C., preferably from −80° C. to −10° C. and more preferably from −40° C. to −20° C.

### Embodiment 3

The coating composition according to any one of embodiments 1 to 2, wherein said first resin has a hydroxyl value in a range of from 100 to 240 mgKOH/g and preferably from 150 to 200 mgKOH/g.

### Embodiment 4

The coating composition according to any one of embodiments 1 to 3, wherein said first resin has a weight average molecular weight in a range of from 2,000 to 10,000 and preferably from 4,000 to 8,000.

### Embodiment 5

The coating composition according to any one of embodiments 1 to 4, wherein said first resin is at least one acrylic resin and preferably a hydroxyl alkyl (meth)acrylate resin having C₁-C₁₀ and preferably C₂-C₆ alkyl groups.

### Embodiment 6

The coating composition according to any one of embodiments 1 to 5, wherein said resin (B-1) has a Tg in a range of from 0° C. to 30° C. and preferably from 5° C. to 20° C.

### Embodiment 7

The coating composition according to any one of embodiments 1 to 6, wherein said resin (B-1) has a hydroxyl value in a range from 100 to 240 mgKOH/g, and preferably from 150 to 200 mgKOH/g.

### Embodiment 8

The coating composition according to any one of embodiments 1 to 7, wherein said resin (B-1) has a weight average molecular weight in a range from 2,000 to 10,000 and preferably in a range from 3,000 to 7,000.

### Embodiment 9

The coating composition according to any one of embodiments 1 to 8, wherein said resin (B-1) is at least one acrylic resin and preferably ahydroxyl alkyl (meth)acrylate resin having C₁-C₁₀ and preferably C₂-C₆ alkyl groups.

### Embodiment 10

The coating composition according to any one of embodiments 1 to 5, wherein said resin (B-2) has a Tg of at least 20° C. and preferably at least 30° C.

### Embodiment 11

The coating composition according to any one of embodiments 1 to 10, wherein said resin (B-2) has a hydroxyl value in a range of from 100 to 200 mgKOH/g and preferably from 130 to 170 mgKOH/g.

### Embodiment 12

The coating composition according to any one of embodiments 1 or 11, wherein said resin (B-2) has a weight average molecular weight in a range from 2,000 to 10,000, preferably in a range from 3,000 to 7,000.

### Embodiment 13

The coating composition according to any one of embodiments 1 to 12, wherein said resin (B-2) is at least one acrylic resin and preferably a hydroxyl alkyl (meth)acrylate resin having C₂-C₁₀ and prefearbly C₂-C₆ alkyl groups.

### Embodiment 14

The coating composition according to any one of embodiments 1 to 13, wherein the ratio by molar between NCO groups in polyisocyanate and hydroxyl groups in both of the first resin and the second resin is in a range of from 1.6:1 to 0.7:1 and preferably from 1.35:1 to 1.05:1.

### Embodiment 15

The coating composition according to any one of embodiments 1 to 14, wherein the amount of said amino resin is in a range of from 1% to 30%, preferably from 5% to 15% by weight based on the total weight of the coating composition.

### Embodiment 16

The coating composition according to any one of embodiments 1 to 15, wherein said amino resin is melamine resin.

### Embodiment 17

The coating composition according to any one of embodiments 1 to 16, wherein the coating composition further comprises a hydroxyl containing polyester resin.

### Embodiment 18

An article coated by the coating composition according to any one of embodiments 1 to 17, wherein said article preferably has metal substrates.

### EXAMPLES

The invention is described in more practical terms below by means of illustrative examples, but the invention is not limited in any way by these illustrative examples.

The performance of the paint films obtained with coating compositions of the present invention was determined in the ways indicated below.

### Performance Tests on Clearcoat

### (1) Appearance

The appearance of dried and cured clearcoat is evaluated by its surface texture, which is measured by BYK wave-scan dual. Surface texture is a mixture of various textures, ranging from very fine to very course. BYK wave-scan dual measures the surface textures at different scale levels, which is differentiated to six categories, identified by wavelength (Du, Wa, Wb, Wc, Wd, We). Based on these measured data, Lw, Sw are calculated by the equipment and denotes the appearance level of the paint. A lower Lw, Sw value represents a better performance in appearance. Usually a good appearance performance is defined by Lw<5 and Sw<20 at the same time.

(2) Scratch Resistance Scratch Resistance is evaluated by 20° gloss retention after dry scratch. Dry scratch was created by a crockmeter equipped with PERSI abrasive paper (grain size: 10 micron). During the test, 15 back/forth repeats were performed. 20° gloss before and after dry scratch was compared. A higher gloss retention represents a better performance in scratch resistance. The 20° gloss retention of conventional polyurethane 2K clearcoat is about 40% measured by the method described above.

### (3) Hardness

Hardness of the coating is evaluated by pencil hardness, which follows the GB/T standard 6739-2006.

### (4) VOC

VOC is evaluated according to the method described in GB/T 38597/2020, GB/T 1725-2007 and GB/T 23985-2009 based on solid content measurement. Solid content is measured by the following process: 1 g of sample is weighed in an aluminum pan with the diameter of 75 mm, which is subsequently baked at 105° C. for 1 h. VOC calculation is preceded following the equation listed below. For all the inventive samples and comparative samples listed in this invention, ρ, the density of coating sample measured is 0.97 g/mL.

$$ρ ( VOC ) = ( 100 - NV ) \times ρ \times 10$$

ρ(VOC)=sample VOC (calcuated), g/L
NV=sample solid content, expressed in mass fraction (%)
ρ=the density of the coating sample measured at 23° C., g/mL

The polyacrylates in the following preparation examples are prepared according to the monomer composition and ratio by weight shown in Table 1.

### Materials

Setalux® 91756 VS-60 YA is a sag control agent from Allnex
Cymel® 327 is an amino resin crosslinker from Allnex
Luwipal® 018 is an amino resin crosslinker from BASF
Cycat® 4045 is a catalyst from Allnex
BYK355 is a leveling agent from BYK Chemie
Disperbyk 161 is a leveling agent from BYK Chemie
BYK 325 is a leveling agent from BYK Chemie
BYK 315 is a leveling agent from BYK Chemie
Disparlon® OX-883HF is a defoamer from King Industries
Tinuvin® 5248 is a light stabiizier from BASF

### Preparation Example 1

A stainless-steel reactor equipped with reflux condenser and N₂ inlet is charged with 27.9 parts by weight of a mixture of solvent naphtha 160/180 (SN) and caprolactone, and this initial charge is heated to 140° C. Thereafter, over a period of 4.75 hours, an initiator solution (5.1 parts by weight of tertiary butylperoxy-2-ethylhexanoate (TBPEH) in 3.7 parts by weight of solvent naphtha 160/180 (SN)) is metered in at a uniform rate with stirring. The monomer mixture containing 6.4 parts by weight of styrene (St), 30.1 parts by weight of 2-ethyl hexyl acrylate (EHA), 23.1 parts by weight of 2-hydroxyethyl acrylate (2-HEA) is metered in at a uniform rate with stirring over a period of 4 hours. Afterwards, the reaction mixture is heated to 160° C. and held for 4 hours. Then the reaction mixture is cooled to 60° C. and diluted by the addition of 5.4 parts by weight of solvent naphtha 160/180 (SN). The solid content of the resulting solution of polyacrylate is 65% by weight. The resulting polyacrylate (i.e., Low Tg resin-1 in Table 1) possesses a weight average molecular weight (M_{W}) of 6,500 g/mol, an OH value of 175 mg KOH/g and a Tg of −30° C.

### Preparation Example 2

A stainless-steel reactor equipped with reflux condenser and N₂ inlet is charged with 27.9 parts by weight of a mixture of solvent naphtha 160/180 (SN) and caprolactone, and this initial charge is heated to 140° C. Thereafter, over a period of 4.75 hours, an initiator solution (5.1 parts by weight of tertiary butylperoxy-2-ethylhexanoate (TBPEH) in 1.9 parts by weight of solvent naphtha 160/180 (SN)) is metered in at a uniform rate with stirring. The monomer mixture containing 6.4 parts by weight of styrene (St), 30.1 parts by weight of 2-ethyl hexyl acrylate (EHA), 23.1 parts by weight of 2-hydroxyethyl acrylate (2-HEA) is metered in at a uniform rate with stirring over a period of 4 hours. Afterwards, the reaction mixture is heated to 160° C. and held for 4 hours. Then the reaction mixture is cooled to 60° C. and diluted by the addition of 5.4 parts by weight of solvent naphtha 160/180 (SN). The solid content of the resulting solution of polyacrylate is 65% by weight. The resulting polyacrylate (i.e., Low Tg resin-2 in Table 1) possesses a weight average molecular weight (M_{W}) of 13,000 g/mol, an OH value of 175 mg KOH/g and a Tg of −30° C.

### Preparation Example 3

A stainless-steel reactor equipped with reflux condenser and N₂ inlet is charged with 27.9 parts by weight solvent naphtha 160/180 (SN) and this initial charge is heated to 140° C. Thereafter, over a period of 4.75 hours, an initiator solution (5.1 parts by weight of tertiary butylperoxy-2-ethylhexanoate (TBPEH) in 3.7 parts by weight of solvent naphtha 160/180 (SN)) is metered in at a uniform rate with stirring. The monomer mixture containing 15.2 parts by weight of styrene (St), 19.6 parts by weight of n-butylacrylate (nBA), 23.7 parts by weight of 2-hydroxyethyl methacrylate (2-HEMA) is metered in at a uniform rate with stirring over a period of 4 hours. Afterwards, the reaction mixture is heated to 160° C. and held for 4 hours. Then the reaction mixture is cooled to 60° C. and diluted by the addition of 5.4 parts by weight of solvent naphtha 160/180 (SN). The solid content of the resulting solution of polyacrylate is 60% by weight. The resulting polyacrylate (i.e., Medium Tg resin in Table 1) possesses a weight average molecular weight (M_{W}) of 5,700 g/mol, an OH value of 175 mg KOH/g and a Tg of 12° C.

### Preparation Example 4

A stainless-steel reactor equipped with reflux condenser and N₂ inlet is charged with 28 parts by weight of solvent naphtha 160/180 (SN), and this initial charge is heated to 160° C. Thereafter, over a period of 4.75 hours, an initiator solution (0.9 parts by weight of di-tert-butyl peroxide (DTBP) in 3.4 parts by weight of solvent naphtha 160/180 (SN)) is metered in at a uniform rate with stirring. The monomer mixture containing parts by 13.9 weight of styrene (St), 23.6 parts by weight of 2-hydroxyethyl acrylate (2-HEA), 6.7 parts by weight of n-butyl acrylate (nBA), 11.4 parts by weight of cyclohexyl methacrylate (CHMA) and 1.4 parts by weight of acrylic acid (AA) is metered in at a uniform rate with stirring over a period of 4 hours. Afterwards, the reaction mixture is held for 4 hours. Then the reaction mixture is cooled to 60° C. and diluted by the addition of 16.9 parts by weight of butyl acetate (BA). The solid content of the resulting solution of polyacrylate is 60% by weight. The resulting polyacrylate (i.e., High Tg resin-1 in Table 1) possesses a weight average molecular weight (Mw) of 6000 g/mol, an OH value of 167 mg KOH/g and a Tg of 32° C.

### Preparation Example 5

A stainless-steel reactor equipped with reflux condenser and N₂ inlet is charged with 28 parts by weight of solvent naphtha 160/180 (SN), and this initial charge is heated to 150° C. Thereafter, over a period of 4.75 hours, an initiator solution (0.9 parts by weight of di-tert-butyl peroxide (DTBP) in 3.4 parts by weight of solvent naphtha 160/180 (SN)) is metered in at a uniform rate with stirring. The monomer mixture containing parts by 5.1 weight of styrene (St), 20.3 parts by weight of 2-hydroxypropyl methacrylate (2-HPMA), 7.7 parts by weight of n-butyl methacrylate (nBMA), 17.2 parts by weight of t-butyl acrylate (tBA) and 0.4 parts by weight of acrylic acid (AA) is metered in at a uniform rate with stirring over a period of 4 hours. Afterwards, the reaction mixture is held for 4 hours. Then the reaction mixture is cooled to 60° C. and diluted by the addition of 16.9 parts by weight of butyl acetate (BA). The solid content of the resulting solution of polyacrylate (i.e., Hight Tg resin-2 in Table 1) is 53% by weight. The resulting polyacrylate (i.e., Hight Tg resin-2 in Table 1) possesses a weight average molecular weight (M_{W}) of 5,500 g/mol, an OH value of 150 mg KOH/g and a Tg of 40° C.

TABLE 1
Resin Features

| | Monomer composition & | OH- | Tg | | |
|---|---|---|---|---|---|
| | ratio by weight | (Meth)acrylate | (° C.) | Mw | OHV |
| Low Tg | 2-HEA/St/EHA/Caprolactone | 2-HEA | −30 | 6,500 | 175 |
| resin-1 | 23.1/6.4/30.1/4.5 | | | | |
| Medium | 2-HEMA/St/nBA | 2-HEMA | 12 | 5,700 | 175 |
| Tg resin | 23.7/15.2/19.6 | | | | |
| Low Tg | 2-HEA/St/EHA/Caprolactone | 2-HEA | −30 | 13,000 | 175 |
| resin-2 | 23.1/6.4/30.1/4.5 | | | | |
| High Tg | St/nBA/CHMA/2-HEA/AA | 2-HEA | 32 | 6,000 | 167 |
| resin-1 | 13.9/6.7/11.4/23.6/1.4 | | | | |
| High Tg | 2-HPMA/St/nBMA/tBA/AA | 2-HPMA | 40 | 5,500 | 150 |
| resin-2 | 20.3/5.1/7.7/17.2/0.4 | | | | |

St: Styrene;
2-HEA: 2-hydroxyl ethylacrylate;
EHA: 2-ethylhexyl acrylate;
2-HEMA: 2-hydroxyl ethyl methacrylate;
n-BA: n-butylacrylate;
nBMA: n-butyl methacrylate;
CHMA: cyclohexyl methacrylate;
AA: acrylic acid;
t-BA: tert-butyl acrylate;
2-HPMA: 2-hydroxypropyl methacrylate

### Preparation of 2K Clearcoat Composition

Table 2 describes the composition of Component I for 2K clearcoat composition. All components listed in the table are mixed subsequently to obtain Component I. To obtain Component II, Desmodur 3390 (from Covestro) was diluted to 80% by weight in a mixture of solvent naphtha and butylacetate (1:1 by weight). The molar ratio of NCO of component II to total OH of Component I is 1.2:1.

TABLE 2
Compositions for Component I of the 2K coating composition

| Components of Component I of | Examples | | | | | Comparative Examples | | | | |
|---|---|---|---|---|---|---|---|---|---|---|
| the 2K coating composition | 1 | 2 | 3 | 4 | 5 | 1 | 2 | 3 | 4 | 5 |
| Low Tg resin-1 (primary OH) | 37 | 23 | 37 | 37 | 37 | — | — | — | 37 | — |
| Medium Tg resin (primary OH) | — | — | — | — | 9 | — | — | — | — | 37 |
| High Tg resin-2 (secondary OH) | 9 | 23 | 9 | 9 | — | — | — | 46 | — | 9 |
| Setalux ® 91756 VS-60 YA | 14 | 14 | 14 | 14 | 14 | 46 | — | — | 9 | — |
| Cymel ® 327 | 10 | 10 | — | — | 10 | — | 46 | — | — | — |
| Luwipal ® 018 | — | — | 10 | 10 | — | 14 | 14 | 14 | 14 | 14 |
| BYK355 | 1.313 | 1.313 | 1.313 | 1.313 | 1.313 | 10 | 10 | 10 | 0 | 10 |
| Cycat ® 4045 | 1.5 | 1.5 | 1.5 | — | 1.5 | — | — | — | — | — |
| Butyl Acetate | 10 | 10 | 10 | 10 | 10 | 1.313 | 1.313 | 1.313 | 1.313 | 1.313 |
| Ethyl 3-Ethoxypropionate (EEP) | 5 | 5 | 5 | 5 | 5 | 1.5 | 1.5 | 1.5 | 1.5 | 1.5 |
| n-butanol | 1.4 | 1.4 | 1.4 | 1.4 | 1.4 | 10 | 10 | 10 | 10 | 10 |
| Dibasicester (DBE) | 1 | 1 | 1 | 1 | 1 | 5 | 5 | 5 | 5 | 5 |
| Disperbyk 161 | 0.04 | 0.04 | 0.04 | 0.04 | 0.04 | 1.4 | 1.4 | 1.4 | 1.4 | 1.4 |
| BYK 325 | 0.105 | 0.105 | 0.105 | 0.105 | 0.105 | 1 | 1 | 1 | 1 | 1 |
| BYK 315 | 0.02 | 0.02 | 0.02 | 0.02 | 0.02 | 0.04 | 0.04 | 0.04 | 0.04 | 0.04 |
| Disparlon OX-883HF | 0.105 | 0.105 | 0.105 | 0.105 | 0.105 | 0.105 | 0.105 | 0.105 | 0.105 | 0.105 |
| Tinuvin 5248 | 1.8 | 1.8 | 1.8 | 1.8 | 1.8 | 0.02 | 0.02 | 0.02 | 0.02 | 0.02 |
| Total | 92.283 | 92.283 | 92.283 | 90.783 | 92.283 | 0.105 | 0.105 | 0.105 | 0.105 | 0.105 |

### Preparation of Dried and Cured Film

Mix Component I and Component II of each 2K clearcoat composition and stir the mixture evenly; spray the mixture onto steel plates and bake for 20minutes at 140° C.

The evaluation of clearcoat films were performed in a multilayered coating comprising a black aqueous basecoat produced from a commercial black aqueous basecoat material (Colorbrite) from BASF Shanghai Coating Ltd. The black basecoat was chosen since it allowed optimum observation of changes in the appearance of the multicoat coating systems.

TABLE 3
Results

| | Examples | | | | | Comparative Examples | | | | |
|---|---|---|---|---|---|---|---|---|---|---|
| Results | 1 | 2 | 3 | 4 | 5 | 1 | 2 | 3 | 4 | 5 |
| Solid content | 59% | 57% | 57% | 58% | 60% | 57% | 60% | 57% | 58% | 59% |
| Viscosity (s) measured | 31.38 | 29 | 28.9 | 28.4 | 36.8 | 31 | 54 | 48.9 | 26 | 48.9 |
| by Ford Cup 4# @ 23° C. | | | | | | | | | | |
| Hardness* | HB | HB | HB | B | HB | F | HB | F | 4B | F |
| Gloss retention | 64% | 58% | 67% | 57% | 63% | 39% | 78% | 54% | 40% | 56% |
| Lw | 1.6 | 1.6 | 1.7 | 2.1 | 1.7 | 1.8 | 4.8 | 3.5 | 4.6 | 2.4 |
| Sw | 8.3 | 8.3 | 9.5 | 7.9 | 8.1 | 10.1 | 9.8 | 10.4 | 13.4 | 8.9 |

*The minimum requirement of hardness for application is “B”.

It can be seen from Table 3 that only the invented examples show high solid content (i.e., low VOC) and low viscosity simultaneously. And the otained clearcoat layers exihibit good appearance and scratch resistance as well as sufficient hardness, while comparative examples show one or more drawbacks.

It will be apparent to one person skilled in the art that various modifications and variations can be made in the present invention without departing from the scope or spirit of the present invention. It is intended that the embodiments and examples be considered as exemplary only. Thus, it is intended that the present invention covers such modifications and variations as come within the scope of the appended claims and their equivalents.

1. A 2K clearcoat coating composition comprising
(A) from 10% to 70% by weight of a first resin having at least one primary hydroxyl group;
(B) from 2% to 40% by weight of a second resin comprising a resin (B-1) having at least one primary hydroxyl group and/or a resin (B-2) having at least one secondary hydroxyl group; and
(C) a crosslinker comprising at least one polyisocyanate and at least one amino resin, wherein the weight percentages of components (A) and (B) are based on the total weight of the coating composition and the ratio by weight between components (A) and (B) is in a range of from 6:1 to 1:2;
wherein said first resin has a Tg of from −80° C. to 0° C.;
wherein said first resin has a weight average molecular weight in a range of from 2,000 to 10,000; and
wherein said resin (B-2) has a Tg of at least 20° C.

2. (canceled)

3. The coating composition according to claim 1, wherein said first resin has a hydroxyl value in a range of from 100 to 240 mgKOH/g.

4. (canceled)

5. The coating composition according to claim 1, wherein said first resin is at least one acrylic resin.

6. The coating composition according to claim 1, wherein said resin (B-1) has a Tg in a range of from 0° C. to 30° C..

7. The coating composition according to claim 1, wherein said resin (B-1) has a hydroxyl value in a range from 100 to 240 mgKOH/g.

8. The coating composition according to claim 1, wherein said resin (B-1) has a weight average molecular weight in a range of from 2,000 to 10,000.

9. The coating composition according to claim 1, wherein said resin (B-1) is at least one acrylic resin.

10. (canceled)

11. The coating composition according to claim 1, wherein said resin (B-2) has a hydroxyl value in a range of from 100 to 200 mgKOH/g.

12. The coating composition according to claim 1, wherein said resin (B-2) has a weight average molecular weight in a range of from 2,000 to 10,000.

13. The coating composition according to claim 1, wherein said resin (B-2) is at least one acrylic resin.

14. The coating composition according to claim 1, wherein the ratio by molar between NCO groups in polyisocyanate and hydroxyl groups in both of the first resin and the second resin is in a range of from 1.6:1 to 0.7:1.

15. The coating composition according to claim 1, wherein the amount of said amino resin is in a range of from 1% to 30% by weight based on the total weight of the coating composition.

16. The coating composition according to claim 1, wherein said amino resin is a melamine resin.

17. The coating composition according to claim 1, wherein the coating composition further comprises a hydroxyl containing polyester resin.

18. An article coated by the coating composition according to claim 1.

19. The 2K clearcoat coating composition according to claim 1, comprising:
(A) from 20% to 50% by weight of a first resin having at least one primary hydroxyl group;
(B) from 5% to 25% by weight of a second resin comprising a resin (B-1) having at least one primary hydroxyl group and/or a resin (B-2) having at least one secondary hydroxyl group; and
(C) a crosslinker comprising at least one polyisocyanate and at least one amino resin,
wherein the weight percentages of components (A) and (B) are based on the total weight of the coating composition and the ratio by weight between components (A) and (B) is in a range of from 4:1 to 1:1;
wherein said first resin has a Tg of from −80° C. to −10° C.;
wherein said first resin has a weight average molecular weight in a range of from 2,000 to 10,000; and
wherein said resin (B-2) has a Tg of at least 20° C.

20. The coating composition according to claim 1, wherein said first resin has a hydroxyl value in a range of from 150 to 200 mgKOH/g.

21. The coating composition according to claim 1, wherein said first resin is at least a hydroxyl alkyl (meth)acrylate resin having C₁-C₁₀ alkyl groups.

22. The coating composition according to claim 1, wherein said resin (B-1) has a Tg in a range of from 5° C. to 20° C.

23. The article according to claim 18, wherein said article has metal substrates.
